(19) United States
(12) Patent Application Publication
(10) Pub. No.: US 2011/0069092 A1
(43) Pub. Date: Mar. 24, 2011

(54) LIQUID CRYSTAL TEMPERATURE SENSOR, TEMPERATURE DETECTING METHOD BY LIQUID CRYSTAL TEMPERATURE SENSOR, LIQUID CRYSTAL DEVICE AND LIQUID CRYSTAL DEVICE DRIVE METHOD

(76) Inventors: Tomoo Furukawa, Osaka (JP); Kazuyoshi Fujioka, Osaka (JP)

(21) Appl. No.: 12/736,858

(22) PCT Filed: Apr. 6, 2009
(86) PCT No.: PCT/JP2009/057063

§ 371 Date: Nov. 17, 2010

(30) Foreign Application Priority Data
Jun. 11, 2008 (JP) 2008-153061

(51) Int. Cl. G09G 5/10; G09G 5/00

(52) U.S. Cl. 345/690; 345/204

(57) ABSTRACT

Provided is a liquid crystal temperature sensor including: a liquid crystal panel including a first substrate, a second substrate, and a liquid crystal layer; and a control section for controlling driving of the liquid crystal panel, the first substrate including (i) a plurality of signal lines intersecting with each other and (ii) switching elements correspondingly provided to intersections of the plurality of signal lines, the liquid crystal panel including a plurality of picture elements arranged in a matrix. In at least one embodiment, the control section includes a current-to-temperature information converting section for (i) detecting an amount of current flowing into at least one of the picture elements and (ii) converting the amount of current detected, into temperature information of part of the liquid crystal layer which part corresponds to the at least one of the picture elements.

### TECHNICAL FIELD

The present invention relates to a liquid crystal temperature sensor, a method for temperature detection by a liquid crystal temperature sensor, a liquid crystal device, and a method for driving a liquid crystal device.

Specifically, the present invention relates to (i) a liquid crystal temperature sensor which is capable of detecting a temperature of a liquid crystal layer or a liquid crystal panel, (ii) a method for detecting a temperature of a liquid crystal layer or a liquid crystal panel by the liquid crystal temperature sensor, (iii) a liquid crystal device which can be driven by overshoot driving according to the temperature of the liquid crystal layer or the liquid crystal panel, and (iv) a method for driving the same.

### BACKGROUND ART

Along with development of personal computers, television receivers, and other devices having a lighter weight and a thinner thickness, there has conventionally been a demand for display devices having a lighter weight and a thinner thickness. In order to meet this demand, flat panel displays such as liquid crystal display devices are now in wide use, in place of cathode ray tube (CRT)-based display devices.

Recently, the liquid crystal display devices are commonly used not only as display devices for computers but also as display devices for television receivers. Thus, there is an increasing need for displaying a moving image with the liquid crystal display devices.

However, the liquid crystal display device generally has a low response speed, as compared with other display devices such as CRT-based display devices. Therefore, it is not easy for the liquid crystal display device to display a moving image appropriately.

(OS Driving)

As a measure for improving the response speed, so-called overshoot driving (OS driving, overdriving) has been developed, which is a method for driving the liquid crystal display device.

The overshoot driving is a driving method that applies an emphasis voltage to a liquid crystal material so as to make a response of the liquid crystal material quicker, thereby improving the response speed.

Specifically, the overshoot driving is a method for driving the liquid crystal display device while changing a display tone for a certain pixel from a tone T1 to another tone T2 not simply by applying to the liquid crystal material a voltage corresponding to the tone T2, but by applying to the liquid crystal material an emphasis voltage which is determined in advance based on how and how much the tone T1 is to be changed to the tone T2.

Typically, such the overshoot driving is realized by conversion of an input tone with use of a look-up table (LUT). Specifically, such a look-up table is prepared in which (i) a pair of the tone T1 and the tone T2 before and after a tone change is associated with (ii) a tone T3 after conversion, and the look-up table is stored in a memory or the like. By referring to the look-up table, an input tone is converted.

(Temperature Dependency)

The liquid crystal material has quite great temperature dependency in its physical property. Therefore, the liquid crystal display device significantly changes its response speed according to a change in the temperature of the liquid crystal material. For this reason, even if such a look-up table for the overshoot driving is set with which a sufficient improvement effect in the response speed is expected at a certain temperature, the look-up table may provide an insufficient or excess improvement effect in the response speed due to a change in the temperature of the liquid crystal material. This may result in impairment in the display quality of the liquid crystal display device.

In view of this, as a measure for preventing the impairment in the display quality caused by the temperature change, such a technique has been developed in which a plurality of look-up tables as above are set for respective temperatures of the liquid crystal material, and a look-up table to be used is switched one from another depending on the temperature detected by a temperature sensor. Further, in association with this technique, various techniques for detecting the temperature of the liquid crystal display device have been proposed.

(Patent Literature 1)

For example, Patent Literature 1 (shown below) describes a liquid crystal display device including, for the purpose of estimating a temperature of a liquid crystal display panel more accurately, (i) a first temperature sensor provided behind a backlight unit and (ii) a second temperature sensor, provided outside a housing, which detects an outside air temperature.

In the liquid crystal display device of Patent Literature 1, panel temperature estimating means estimates the temperature of the liquid crystal display panel based on the respective temperatures detected by the first temperature sensor and the second temperature sensor.

(Patent Literature 2)

Patent Literature 2 (shown below) describes a liquid crystal display device including, for the purpose of detecting a temperature of the display device accurately, a temperature sensor provided in a peripheral region, which is in the outside of a display region in a liquid crystal display panel assembly.

### CITATION LIST

### Patent Literatures

[Patent Literature 1]

Japanese Patent Application Publication, Tokukai, No. 2007-93939 A (Publication Date: Apr. 12, 2007)

[Patent Literature 2]

Japanese Patent Application Publication, Tokukai, No. 2007-25685 A (Publication Date: Feb. 1, 2007)

### SUMMARY OF INVENTION

However, the above conventional liquid crystal display devices have a problem that it is difficult for these devices to detect a temperature of the liquid crystal material accurately.

Furthermore, the above conventional liquid crystal display devices have a problem of increasing the number of manufacturing steps and the manufacturing cost, in manufacturing these display devices.

(Accurate Temperature Detection)

As described above, the liquid crystal display device described in Patent Literature 1 indirectly estimates the temperature of the liquid crystal material with use of the temperature sensor provided behind the backlight unit, etc. Therefore, it is difficult for this liquid crystal display device to accurately detect the temperature of the liquid crystal material.

(Manufacturing Cost, Etc.)

Further, for the liquid crystal display device described in Patent Literature 1, the temperature sensors are separately provided on the backlight unit and the like. This increases the manufacturing cost.

Meanwhile, in the liquid crystal display device described in Patent Literature 2, the temperature sensor is incorporated into the liquid crystal display panel. However, since the temperature sensor is additionally provided therein separately from bus lines and electrodes, which are constructions originally provided in the liquid crystal display panel, a step for providing the temperature sensor is necessary. This increases the number of manufacturing steps.

The present invention was made in view of the foregoing problems, and an object of the present invention is to provide (i) a liquid crystal temperature sensor which is capable of accurately detecting a temperature of a liquid crystal layer while avoiding increasing the manufacturing cost and the number of manufacturing steps and (ii) a method for temperature detection by the liquid crystal temperature sensor.

Further, an object of the present invention is to provide (i) a liquid crystal device which is capable of performing appropriate compensation to optical response characteristics of a liquid crystal panel even if a temperature of a liquid crystal layer or the liquid crystal panel changes and (ii) a method for driving the liquid crystal device.

In order to attain the foregoing objects, a liquid crystal sensor of the present invention includes:

a liquid crystal panel including a first substrate, a second substrate, and a liquid crystal layer sandwiched between the first substrate and the second substrate; and

a control section for controlling driving of the liquid crystal panel,

the liquid crystal panel including a plurality of picture elements arranged in a matrix,

the control section including a current-to-temperature information converting section for (i) detecting an amount of current flowing into at least one of the picture elements and (ii) converting the amount of current detected, into temperature information of part of the liquid crystal layer which part corresponds to said at least one of the picture elements.

In order to attain the foregoing objects, a method for temperature detection by the liquid crystal sensor of the present invention is a method for detecting a temperature of a liquid crystal layer in a liquid crystal temperature sensor, wherein the liquid crystal temperature sensor includes:

a liquid crystal panel including a first substrate, a second substrate, and the liquid crystal layer sandwiched between the first substrate and the second substrate; and

a control section for controlling driving of the liquid crystal panel,

the liquid crystal panel including a plurality of picture elements arranged in a matrix,

said method including the steps of:

detecting an amount of current flowing into at least one of the picture elements; and

converting the amount of current detected, into temperature information.

According to the above configuration and method, by detecting the amount of current flowing into said at least one of the picture elements provided in the liquid crystal panel, it is possible to detect the temperature of the liquid crystal layer.

Specifically, the liquid crystal layer contains a liquid crystal material, whose dielectric constant has temperature dependency. Once the dielectric constant of the liquid crystal material changes, an amount of current flowing into the liquid crystal layer, which contains the liquid crystal material, changes. Therefore, by detecting the amount of current flowing into said at least one of the picture elements, it is possible to detect the temperature of part of the liquid crystal layer which part corresponds to said at least one of the picture elements.

Further, according to the above configuration and method, the amount of current is detected through use of said at least one of the picture elements, which are generally provided in the liquid crystal panel. That is, the above configuration and method are realized without providing the liquid crystal panel with any additional component (e.g., a temperature sensor), which is additionally provided to the liquid crystal panel.

Accordingly, each of the above configuration and method detects the temperature of the liquid crystal layer with less possibility of increasing the manufacturing cost or the number of manufacturing steps.

Further, each of the above configuration and method detects the temperature of the liquid crystal layer based on the current flowing into the liquid crystal layer, which is the target of the temperature detection.

Therefore, each of the above configuration and method is capable of accurately detecting the temperature of the liquid crystal layer, unlike a configuration in which a temperature sensor, etc. for temperature detection is additionally provided at a position separated from a liquid crystal panel, for example.

Thus, according to the above configuration and method, it is possible to provide (i) a liquid crystal temperature sensor which is capable of accurately detecting a temperature of a liquid crystal layer while avoiding increasing the manufacturing cost and the number of manufacturing steps and (ii) a method for temperature detection by the liquid crystal temperature sensor.

Further, the liquid crystal sensor of the present invention can be configured such that:

the current-to-temperature information converting section stores information regarding a correlation between the amount of current and the temperature information; and

based on the information regarding the correlation, the current-to-temperature information converting section converts the amount of current detected, into the temperature information.

According to this configuration, the current-to-temperature information converting section for converting an amount of current to temperature information is in advance provided with information regarding a relationship between amounts of current and temperatures, in other words, tables with which amounts of current are read into temperatures.

This makes it possible to obtain the temperature information more accurately and smoothly.

Furthermore, the liquid crystal sensor of the present invention can be configured such that:

the first substrate includes (i) a plurality of signal lines intersecting with each other and (ii) switching elements correspondingly provided to intersections of the plurality of signal lines;

the plurality of signal lines include source bus lines and gate bus lines wherein the source bus lines and the gate bus lines intersect with each other at the intersections so as to be connected with the respective switching elements correspondingly;

the switching elements are transistor elements;

the control section includes (i) a source driver for controlling the source bus lines and (ii) a gate driver for controlling the gate bus lines; and

the current-to-temperature information converting section detects a consumption current of the source driver so as to detect the amount of current flowing into said at least one of the picture elements.

According to this configuration, the temperature information is obtained with use of bus lines, drivers, etc., each of which is incorporated in advance into a TFT (Thin Film Transistor) active matrix liquid crystal panel. This hardly causes a design change of the liquid crystal panel, a change in the manufacturing steps, etc. Thus, it is possible to obtain a liquid crystal sensor more easily.

Moreover, the liquid crystal sensor of the present invention can be configured such that:

the liquid crystal panel includes (i) a display region, which displays an image, and (ii) a non-display region, which does not display the image, the non-display region being provided along an outer edge of the display region; and

each of said at least one of the picture elements for which the amount of current is detected is a picture element belonging to the non-display region.

According to this configuration, said at least one of the picture elements for which the amount of current is detected belongs to the non-display region. Therefore, it is possible to apply any signal to said at least one of the picture elements, regardless of the image to be displayed on the liquid crystal panel.

Thus, it is possible to apply, to said at least one of the picture elements, a signal suitable for detection of the amount of current. Specifically, for example, it is possible to increase the dielectric constant of the liquid crystal material by application of a high-voltage signal in order to accurately detect the amount of current. For another example, it is possible to apply a constant-voltage signal in order to accurately figure out a change in the amount of current.

Thus, with the above configuration, it is possible to obtain more accurate temperature information.

Furthermore, the liquid crystal sensor of the present invention can be configured such that:

the liquid crystal panel includes (i) a display region, which displays an image, and (ii) a non-display region, which does not display the image, the non-display region being provided along an outer edge of the display region; and

among the picture elements, a picture element belonging to the non-display region includes, among the switching elements, a switching element connected with a corresponding dummy gate bus line, which is, among the gate bus lines, a gate bus line provided for inspection of the liquid crystal panel.

According to this configuration, the amount of current is detected with use of the dummy picture element, which is the picture element connected with the corresponding dummy gate bus line provided for inspection.

Therefore, it is possible to obtain a liquid crystal sensor more easily and with far less possibility of causing a design change of the liquid crystal panel, a change in the manufacturing steps, etc.

Moreover, the liquid crystal sensor of the present invention can be configured such that:

the second substrate includes a black matrix; and

the non-display region is covered with the black matrix when seen in a plane view.

According to this configuration, the non-display region, which includes said at least one of the picture elements for which the amount of current is detected, is covered with the black matrix.

Accordingly, even when any voltage is applied to said at least one of the picture elements, said at least one of the picture elements is not recognized by a main observer of the liquid crystal panel.

Thus, with the above configuration, it is possible to obtain accurate temperature information without impairing the display quality.

Furthermore, the liquid crystal sensor of the present invention can be configured such that:

the first substrate includes the plurality of signal lines intersecting with each other; and

each of the picture elements is demarcated by corresponding ones of the plurality of signal lines intersecting with each other.

Further, a liquid crystal device of the present invention can be a liquid crystal device including:

the above liquid crystal temperature sensor including the liquid crystal panel which is driven by overshoot driving according to input tone data having been subjected to tone conversion with reference to a tone conversion table,

the control section including:

a storing section for storing a plurality of tone conversion tables in which respective different degrees of tone change are set for tone conversion;

a selecting section for selecting, among the plurality of tone conversion tables, a tone conversion table to be referred to; and

a tone converting section for carrying out tone conversion on the input tone data by referring to the tone conversion table selected,

the selecting section selecting, among the plurality of tone conversion tables stored in the storing section, the tone conversion table which is suitable for a temperature of the liquid crystal layer, based on the temperature information supplied by the current-to-temperature information converting section.

Further, in order to attain the foregoing object, a method for driving the liquid crystal device of the present invention is a method for driving a liquid crystal device which includes:

a liquid crystal panel including a first substrate, a second substrate, and a liquid crystal layer sandwiched between the first substrate and the second substrate; and

a control section for controlling driving of the liquid crystal panel,

the liquid crystal panel including a plurality of picture elements arranged in a matrix,

the control section including:

a current-to-temperature information converting section for (i) detecting an amount of current flowing into at least one of the picture elements and (ii) converting the amount of current detected, into temperature information of part of the liquid crystal layer which part corresponds to said at least one of the picture elements;

a storing section for storing a plurality of tone conversion tables in which respective different degrees of tone change are set for tone conversion;

a selecting section for selecting, among the plurality of tone conversion tables, a tone conversion table to be referred to; and

a tone converting section for carrying out tone conversion on input tone data by referring to the tone conversion table selected,

said method including the steps of:

the current-to-temperature information converting section detecting an amount of current flowing into said at least one of the picture elements;

the current-to-temperature information converting section converting the amount of current detected, into temperature information;

based on the temperature information, the selecting section selecting, among the plurality of tone conversion tables stored in the storing section, a tone conversion table which is suitable for a temperature of the liquid crystal layer;

the converting section carrying out tone conversion on input tone data by referring to the tone conversion table selected; and

based on the input tone data on which the tone conversion has been carried out, driving the liquid crystal panel by overshoot driving.

With the above configuration and method, it is possible to determine an application voltage for overshoot driving according to accurate temperature information.

Therefore, even if the temperature of the liquid crystal layer changes, it is possible to perform appropriate compensation to the optical response characteristics.

That is, the liquid crystal material has temperature dependency in its physical property. Therefore, the liquid crystal display device has temperature dependency in its response speed. In view of this, in order that a change in the response speed of the liquid crystal display device is reduced and impairment in the display quality is prevented when the temperature of the liquid crystal material changes, it is necessary to apply to the liquid crystal layer a voltage suitable for the temperature of the liquid crystal material.

As a method therefor, there is so-called overshoot driving, which is previously explained.

In order to reduce, by means of the overshoot driving, a change in the response speed of the liquid crystal display device which change is caused by the temperature change, it is necessary to accurately grasp the temperature of the liquid crystal material, in other words, the temperature of the liquid crystal layer containing the liquid crystal material.

With regard to this, according to the above configuration and method, it is possible to accurately detect the temperature of the liquid crystal layer, as described previously.

Therefore, it is possible to set an application voltage for the overshoot driving so that the application voltage becomes more suitable for each temperature.

Thus, according to the above configuration and method, it is possible to provide (i) a liquid crystal device which is capable of performing appropriate compensation to optical response characteristics of a liquid crystal panel even if a temperature of a liquid crystal layer or the liquid crystal panel changes and (ii) a method for driving the liquid crystal device.

Further, the method for temperature detection by the liquid crystal temperature sensor of the present invention and the method for driving the liquid crystal device can be provided such that:

the first substrate includes (i) a plurality of signal lines intersecting with each other and (ii) switching elements correspondingly provided to intersections of the plurality of signal lines;

each of the picture elements is demarcated by corresponding ones of the plurality of signal lines intersecting with each other.

Further, in order to attain the foregoing objects, a liquid crystal sensor of the present invention can include: a liquid crystal panel including a first substrate, a second substrate, and a liquid crystal layer sandwiched between the first substrate and the second substrate; and a control section for controlling driving of the liquid crystal panel, the first substrate including (i) a plurality of signal lines intersecting with each other and (ii) switching elements correspondingly provided to intersections of the plurality of signal lines, the liquid crystal panel including a plurality of picture elements arranged in a matrix, each of the picture elements being demarcated by corresponding ones of the plurality of signal lines intersecting with each other, the control section including a current-to-temperature information converting section for (i) detecting an amount of current flowing into at least one of the picture elements and (ii) converting the amount of current detected, into temperature information of part of the liquid crystal layer which part corresponds to said at least one of the picture elements.

Further, the liquid crystal sensor of the present invention can be configured such that: the plurality of signal lines include source bus lines and gate bus lines wherein the source bus lines and the gate bus lines intersect with each other at the intersections so as to be connected with the respective switching elements correspondingly; the switching elements are transistor elements; the control section includes (i) a source driver for controlling the source bus lines and (ii) a gate driver for controlling the gate bus lines; and the current-to-temperature information converting section detects a consumption current of the source driver so as to detect the amount of current flowing into said at least one of the picture elements.

Further, a liquid crystal device of the present invention can be a liquid crystal device including: the above liquid crystal panel which is driven by overshoot driving according to input tone data having been subjected to tone conversion with reference to a tone conversion table, the control section including: a storing section for storing a plurality of tone conversion tables in which respective different degrees of tone change are set for tone conversion; a selecting section for selecting, among the plurality of tone conversion tables, a tone conversion table to be referred to; and a tone converting section for carrying out tone conversion on the input tone data by referring to the tone conversion table selected, the selecting section selecting, among the plurality of tone conversion tables stored in the storing section, the tone conversion table which is suitable for a temperature of the liquid crystal layer, based on the temperature information supplied by the current-to-temperature information converting section.

Further, a method for temperature detection by a liquid crystal sensor of the present invention can be a method for detecting a temperature of a liquid crystal layer in a liquid crystal temperature sensor, wherein the liquid crystal temperature sensor includes: a liquid crystal panel including a first substrate, a second substrate, and the liquid crystal layer sandwiched between the first substrate and the second substrate; and a control section for controlling driving of the liquid crystal panel, the first substrate including (i) a plurality of signal lines intersecting with each other and (ii) switching elements correspondingly provided to intersections of the plurality of signal lines, the liquid crystal panel including a plurality of picture elements arranged in a matrix, each of the picture elements being demarcated by corresponding ones of the plurality of signal lines intersecting with each other, said method including the steps of: detecting an amount of current flowing into at least one of the picture elements; and converting the amount of current detected, into temperature information.

Further, a method for driving a liquid crystal device of the present invention can be a method for driving a liquid crystal device, wherein the liquid crystal device includes: a liquid crystal panel including a first substrate, a second substrate, and a liquid crystal layer sandwiched between the first substrate and the second substrate; and a control section for controlling driving of the liquid crystal panel, the first substrate including (i) a plurality of signal lines intersecting with each other and (ii) switching elements correspondingly provided to intersections of the plurality of signal lines, the liquid crystal panel including a plurality of picture elements arranged in a matrix, each of the picture elements being demarcated by corresponding ones of the plurality of signal lines intersecting with each other, the control section including: a current-to-temperature information converting section for (i) detecting an amount of current flowing into at least one of the picture elements and (ii) converting the amount of current detected, into temperature information of part of the liquid crystal layer which part corresponds to said at least one of the picture elements; a storing section for storing a plurality of tone conversion tables in which respective different degrees of tone change are set for tone conversion; a selecting section for selecting, among the plurality of tone conversion tables, a tone conversion table to be referred to; and a tone converting section for carrying out tone conversion on input tone data by referring to the tone conversion table selected, said method including the steps of: the current-to-temperature information converting section detecting an amount of current flowing into said at least one of the picture elements; the current-to-temperature information converting section converting the amount of current detected, into temperature information; based on the temperature information, the selecting section selecting, among the plurality of tone conversion tables stored in the storing section, a tone conversion table which is suitable for a temperature of the liquid crystal layer; the converting section carrying out tone conversion on input tone data by referring to the tone conversion table selected; and based on the input tone data on which the tone conversion has been carried out, driving the liquid crystal panel by overshoot driving.

As described above, the liquid crystal sensor of the present invention includes the control section including the current-to-temperature information converting section for (i) detecting an amount of current flowing into at least one of the picture elements and (ii) converting the amount of current detected, into temperature information of part of the liquid crystal layer which part corresponds to said at least one of the picture elements.

Further, as described above, the method for temperature detection by the liquid crystal temperature sensor of the present invention is a method including the steps of: detecting an amount of current flowing into at least one of the picture elements; and converting the amount of current detected, into temperature information.

This makes it possible to provide (i) a liquid crystal temperature sensor which is capable of accurately detecting a temperature of a liquid crystal layer while avoiding increasing the manufacturing cost and the number of manufacturing steps and (ii) a method for temperature detection by the liquid crystal temperature sensor.

Further, as described above, a method for driving the liquid crystal device of the present invention can be a method for driving the liquid crystal device which includes the control section including: a current-to-temperature information converting section for (i) detecting an amount of current flowing into at least one of the picture elements and (ii) converting the amount of current detected, into temperature information of part of the liquid crystal layer which part corresponds to said at least one of the picture elements; a storing section for storing a plurality of tone conversion tables in which respective different degrees of tone change are set for tone conversion; a selecting section for selecting, among the plurality of tone conversion tables, a tone conversion table to be referred to; and a tone converting section for carrying out tone conversion on input tone data by referring to the tone conversion table selected, said method including the steps of: the current-to-temperature information converting section detecting an amount of current flowing into said at least one of the picture elements; the current-to-temperature information converting section converting the amount of current detected, into temperature information; based on the temperature information, the selecting section selecting, among the plurality of tone conversion tables stored in the storing section, a tone conversion table which is suitable for a temperature of the liquid crystal layer; the converting section carrying out tone conversion on input tone data by referring to the tone conversion table selected; and based on the input tone data on which the tone conversion has been carried out, driving the liquid crystal panel by overshoot driving.

This makes it possible to provide a method for driving a liquid crystal device, which method is capable of performing appropriate compensation to optical response characteristics of a liquid crystal panel even if a temperature of a liquid crystal layer or the liquid crystal panel changes.

### BRIEF DESCRIPTION OF DRAWINGS

FIG. 1 is a block diagram schematically illustrating a configuration of a liquid crystal temperature sensor of an embodiment of the present invention.

FIG. 2 is a view schematically illustrating a configuration of a liquid crystal panel of the embodiment of the present invention.

FIG. 3 is a view illustrating an arrangement of gate bus lines of the embodiment of the present invention.

FIG. 4 is a view illustrating an example of temperature dependency of a dielectric constant of a liquid crystal material.

FIG. 5 is a view illustrating an example of temperature dependency of a consumption current of the liquid crystal panel.

FIG. 6 is a flow chart illustrating how the liquid crystal temperature sensor of the embodiment of the present invention operates.

FIG. 7 is a flow chart illustrating how the liquid crystal temperature sensor of the embodiment of the present invention operates.

FIG. 8 is a block diagram schematically illustrating a configuration of a liquid crystal device of another embodiment of the present invention.

FIG. 9 is a flow chart illustrating how the liquid crystal device of the another embodiment of the present invention operates.

FIG. 10 is a block diagram schematically illustrating a configuration of a liquid crystal device of conventional art.

### DESCRIPTION OF EMBODIMENTS

### Embodiment 1

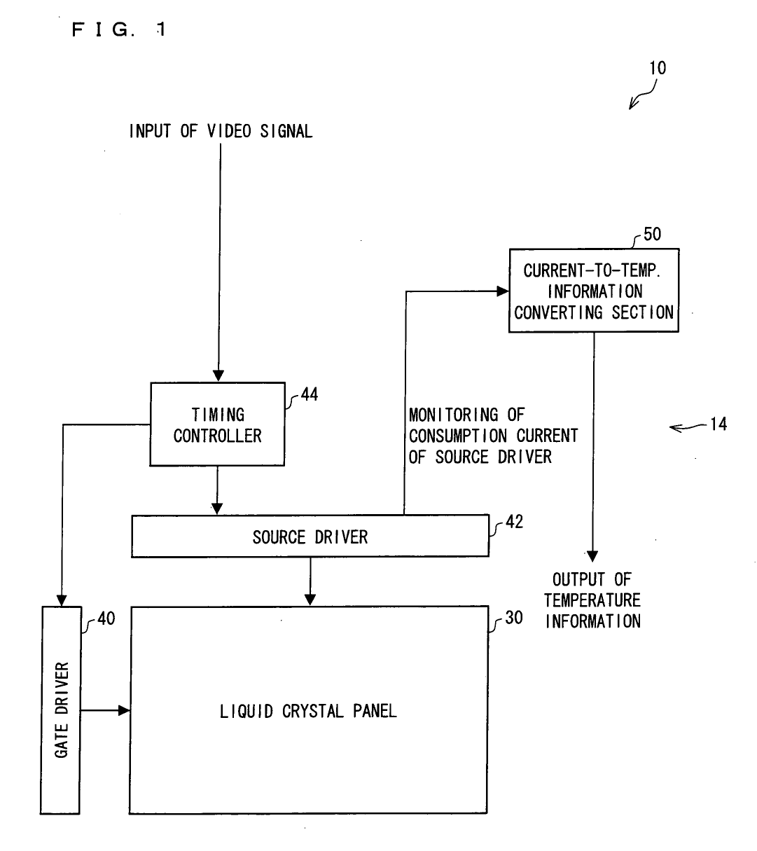

The following will explain an embodiment of the present invention with reference to FIG. 1. FIG. 1 is a block diagram schematically illustrating a configuration of a liquid crystal temperature sensor of the present embodiment.

(Liquid Crystal Temperature Sensor)

As shown in FIG. 1, a liquid crystal temperature sensor 10 of the present embodiment includes a liquid crystal panel 30 and a control section 14.

Specifically, the control section 14 includes (i) a gate driver 40 and a source driver 42 each serving as a signal line connected with the liquid crystal panel 30 and (ii) a timing controller 44 connected with the gate driver 40 and the source driver 42.

Note that one of the features of the liquid crystal temperature sensor 10 of the present embodiment is that the liquid crystal temperature sensor 10 includes a current-to-temperature information converting section 50 connected with the source driver 42. Thanks to functions of the current-to-temperature information converting section 50, it is possible to obtain temperature information from the liquid crystal panel, particularly, from a liquid crystal layer (described later).

(Liquid Crystal Panel)

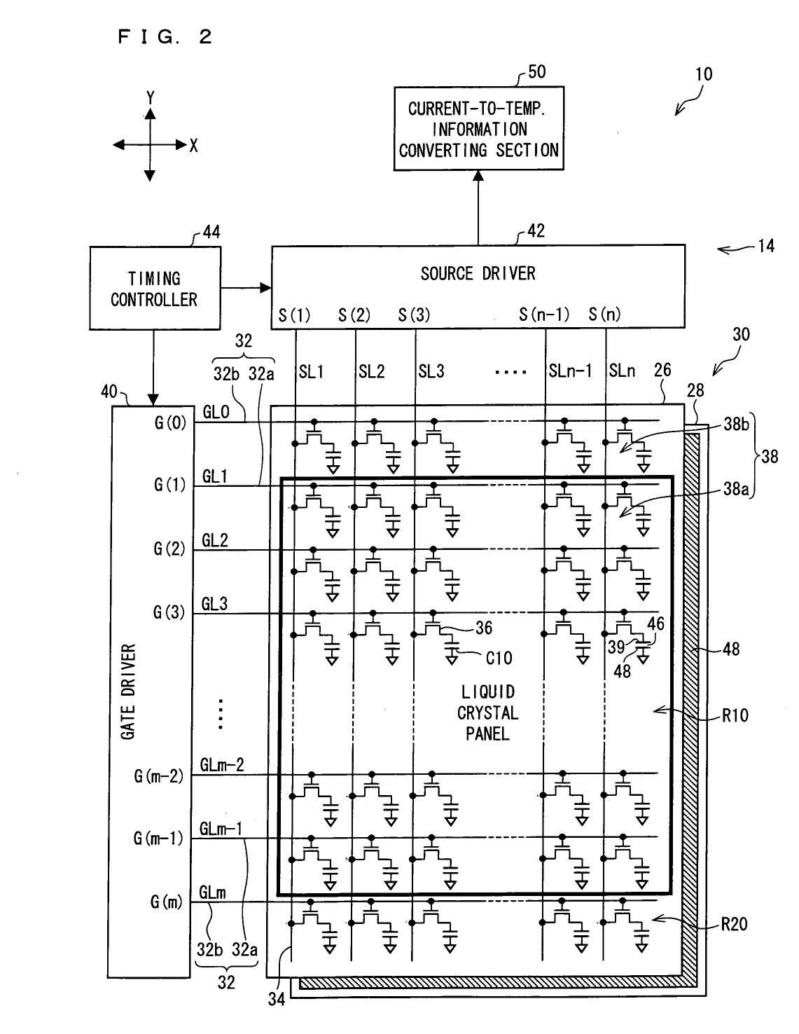

Next, the following will describe the liquid crystal panel 30 with reference to FIG. 2. FIG. 2 is a view schematically illustrating a configuration of the liquid crystal panel 30.

As shown in FIG. 2, the liquid crystal panel 30 includes (i) a first substrate 26 which serves as a TFT (Thin Film Transistor) array substrate, (ii) a second substrate 28 which serves as a color filter substrate, and (iii) a liquid crystal layer 46 sandwiched between the first substrate 26 and the second substrate 28.

(First Substrate)

The first substrate 26 includes a plurality of gate bus lines 32 which extend along a transverse direction (the direction of the arrow X shown in FIG. 2) and which are connected with the gate driver 40. The first substrate 26 also includes a plurality of source bus lines 34 which extend along a longitudinal direction (the direction of the arrow Y shown in FIG. 2) orthogonal to the transverse direction and which are connected with the source driver 42.

Further, at each one of intersections of the gate bus lines 32 and the source bus lines 34, a corresponding TFT element (transistor element), serving as a switching element 36, is provided.

(Second Substrate)

On the other hand, the second substrate 28 includes a counter electrode 48.

Further, a color filter (not illustrated) and a black matrix (not illustrated) are provided between the second substrate 28 and the counter electrode 48.

(Picture Element)

The liquid crystal panel 30 includes substantially rectangular regions demarcated by the plurality of gate bus lines 32 and the plurality of source bus lines 34, the substantially rectangular regions serving as respective picture elements 38. In the liquid crystal panel 30, the plurality of picture elements 38 are arranged in a matrix.

Each of the picture elements 38 includes (i) a corresponding one (1) of the switching elements 36 and (ii) a picture element electrode 39 connected with the switching element 36. Between the picture element electrode 39 and the counter electrode 48, the liquid crystal layer 46 is provided as described previously, and a liquid crystal capacitor C10 is formed.

Note that it is not essential to provide the picture elements 38 in the respective regions demarcated by the gate bus lines 32 and the source bus lines 34. Alternatively, for example, the picture elements 38 can be provided in respective regions extending over the corresponding gate bus lines 32.

(Display Region and Non-Display Region)

In a case where the liquid crystal panel 30 is used as a display panel, the liquid crystal panel 30 can be divided into (i) a display region R10, which is a region including the center of the liquid crystal panel 30, and (ii) a non-display region R20, which is located in the surrounding of the display region R10.

In the liquid crystal temperature sensor 10 of the present embodiment, the picture elements 38 are provided not only in the display region R10 but also in the non-display region R20.

Thus, the plurality of picture elements 38 arranged in a matrix as described above can be divided into (i) picture elements 38a for display, which are picture elements 38 provided in the display region R10, and (ii) dummy picture elements 38b, which are picture elements 38 provided in the non-display region R20.

Similarly, the plurality of gate bus lines 32 can be divided into gate bus lines 32a for display and dummy gate bus lines 32b.

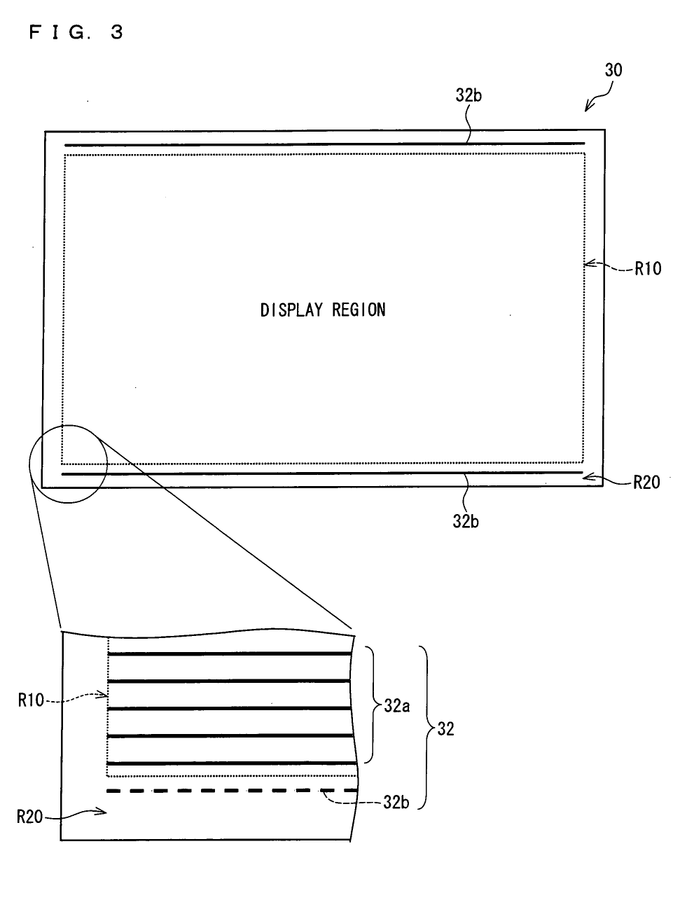

That is, as shown in FIG. 3, which is a view illustrating an arrangement of the gate bus lines 32, gate bus lines 32 provided in the display region R10 serve as the respective gate bus lines 32a for display, whereas gate bus lines 32 provided in the non-display region R20 serve as the respective dummy gate bus lines 32b.

The picture elements 38a for display are connected with the corresponding gate bus lines 32a for display, whereas the dummy picture elements 38b are connected with the corresponding dummy gate bus lines 32b.

(Non-Display Region)

The dummy picture elements 38b and the dummy gate bus lines 32b are covered with the black matrix, which is provided in the second substrate 28. The dummy picture elements 38b and the dummy gate bus lines 32b can be used to inspect (i) the switching elements 36 connected with the corresponding picture elements 38a for display, which are provided in the display region R10, and (ii) bus lines connected with the switching elements 36.

(Temperature Detection)

The following will explain temperature detection carried out by the liquid crystal temperature sensor 10 of the present embodiment.

The liquid crystal temperature sensor 10 of the present embodiment detects, by making use of temperature dependency of a dielectric constant of a liquid crystal material and based on the consumption current of the source driver 42 monitored (detected) by the current-to-temperature information converting section 50, a temperature of the liquid crystal panel 30, consequently a temperature of the liquid crystal layer 46 or a temperature of a liquid crystal material contained in the liquid crystal layer 46. These will be described below in order.

(Characteristics of Liquid Crystal Material)

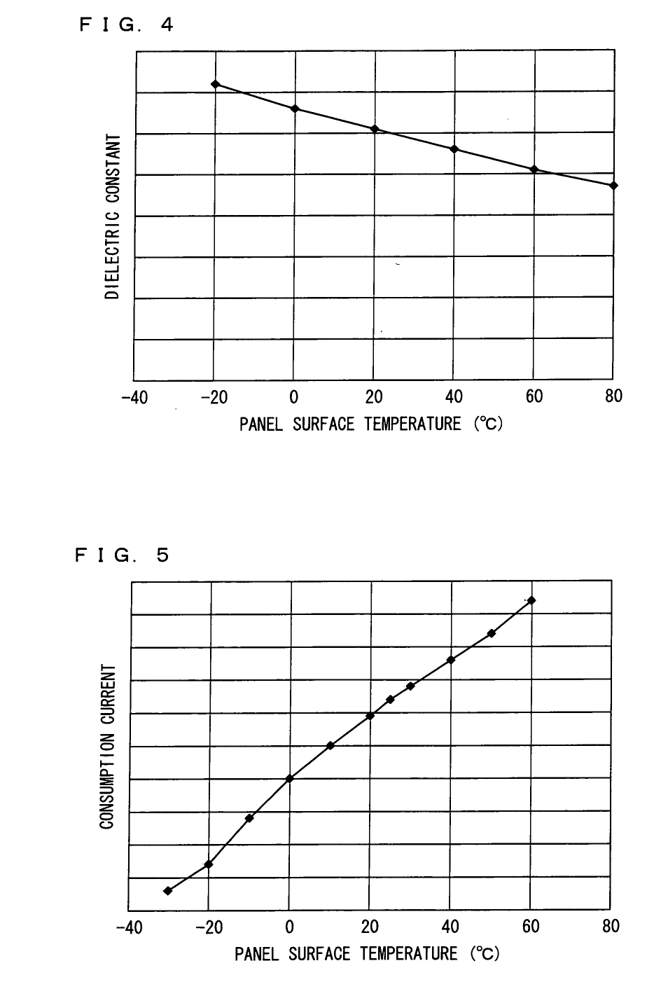

First, characteristics of the liquid crystal material will be described with reference to FIG. 4. FIG. 4 is a view illustrating an example of the temperature dependency of the dielectric constant of the liquid crystal material.

As shown in FIG. 4, there exists a certain relationship between (i) a panel surface temperature of a liquid crystal panel and (ii) a dielectric constant of a liquid crystal material contained in a liquid crystal layer of the liquid crystal panel. Namely, there exists a relationship that as the panel surface temperature increases, the dielectric constant of the liquid crystal material decreases.

Note that the panel surface temperature herein means a surface temperature of the liquid crystal panel, specifically, a temperature of the first substrate or the second substrate, each constituting the liquid crystal panel.

Further, the panel surface temperature of the liquid crystal panel is almost equal to a temperature of the liquid crystal layer or the liquid crystal material contained in the liquid crystal layer. This is because that (i) the liquid crystal layer is in contact with the first substrate and the second substrate of the liquid crystal panel and (ii) the liquid crystal layer is as thin as approximately several um.

(Consumption Current of Liquid Crystal Panel)

Next, the consumption current of the liquid crystal panel will be explained with reference to FIG. 5. FIG. 5 is a view illustrating an example of the temperature dependency of the consumption current of the liquid crystal panel.

As shown in FIG. 5, there exists a certain relationship between (i) a panel surface temperature and (ii) a consumption current of a liquid crystal panel. That is, there exists a relationship that as the panel surface temperature increases, the consumption current of the liquid crystal panel also increases.

The reason why such the relationship is obtained is considered to be that as the panel surface temperature changes, in other words, as the temperature of the liquid crystal material changes, the dielectric constant of the liquid crystal material changes; consequently, the consumption current of the liquid crystal panel changes. More specifically, the reason is considered to be that a change in the dielectric constant of the liquid crystal material causes a change in the capacitances of the liquid crystal capacitors formed in part of the liquid crystal layer which part corresponds to the picture elements; consequently, an amount of current flowing into the picture elements changes.

According to the above relationship, by monitoring the consumption current of the liquid crystal panel, it is possible to calculate back (i) a surface temperature of the liquid crystal panel and (ii) a temperature of the liquid crystal layer or the liquid crystal material.

Further, as shown in FIG. 1, in the liquid crystal temperature sensor 10 of the present embodiment, the current-to-temperature information converting section 50 monitors a consumption current of the source driver 42 as a consumption current of the liquid crystal panel 30.

Note that the current-to-temperature information converting section 50 has been supplied in advance with information regarding a relationship between (i) an amount of consumption current and (ii) a panel surface temperature of the liquid crystal panel or a temperature of the liquid crystal material (information regarding a correlation between an amount of current and temperature information (current-temperature correlation information)).

Therefore, the current-to-temperature information converting section 50 can convert, based on the current-temperature correlation information, a monitored consumption current into a panel surface temperature, consequently, into information regarding a temperature of the liquid crystal material, so as to output the information regarding the temperature.

(Operation Flow Chart)

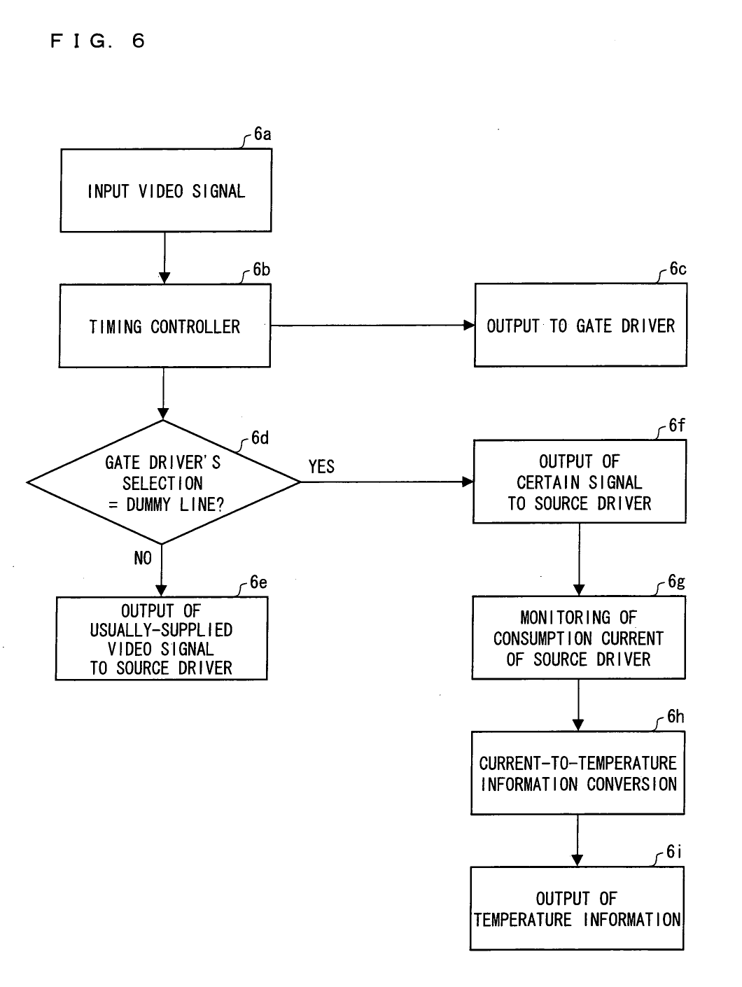

Next, with reference to FIG. 6, the following will explain an example of an operation flow of a liquid crystal temperature sensor of the present embodiment. FIG. 6 is a flow chart illustrating how the liquid crystal temperature sensor operates. The operation flow chart shown in FIG. 6 illustrates a case where a liquid crystal panel included in the liquid crystal temperature sensor is used as a device for display.

In the example shown in FIG. 6, as described above, the liquid crystal panel in the liquid crystal temperature sensor is used as a device for display. Therefore, a timing controller 6b is supplied with a video signal (input video signal 6a).

Then, the timing controller 6b outputs a signal to a gate driver (output to gate driver 6c), and also outputs a signal to a source driver. In this operation, the signal to be outputted to the source driver varies depending on the gate bus line selected by the gate driver, since the liquid crystal temperature sensor is used also as a device for display.

Specifically, it is determined whether a gate bus line for display is selected or a dummy gate bus line is selected (gate driver's selection 6d). If the dummy gate bus line is determined to be selected, a certain signal is outputted to the source driver (output of certain signal to source driver 6f).

Note that the certain signal herein means a signal for detecting a temperature, and is different from a signal for displaying a video. The certain signal is not particularly limited, and may have a maximum voltage that the source driver can supply, for example. As the application voltage becomes higher, the dielectric constant of the liquid crystal material becomes higher. This makes it possible to more accurately monitor an amount of a current, consequently to detect the temperature accurately.

After the output of the certain signal to the source driver (6f), a consumption current of the source driver is monitored (monitoring of consumption current of source driver 6g).

Then, the value of the consumption current (the amount of current) thus monitored is converted into temperature information by the current-to-temperature information converting section (current-to-temperature information conversion 6h). Thereafter, the temperature information thus obtained is outputted (output of temperature information 6i).

On the other hand, in the determining whether a gate bus line for display is selected or a dummy gate bus line is selected (gate driver's selection 6d), if the gate bus line for display is determined to be selected, a usually-supplied video signal is outputted to the source driver (output of certain signal to source driver 6e).

As described above, according to the liquid crystal temperature sensor of the present embodiment, it is possible to detect the temperature by using the dummy picture elements and the dummy gate bus lines, each of which is conventionally provided for inspection, without providing any additional wiring.

In addition, according to the liquid crystal temperature sensor of the present embodiment, the temperature is detected by using the bus lines and the like directly formed in the first substrate, which is considered to have a temperature almost equal to that of the liquid crystal material because the first substrate is in contact with the liquid crystal material. This makes it possible to detect the temperature more accurately.

(Temperature Sensor)

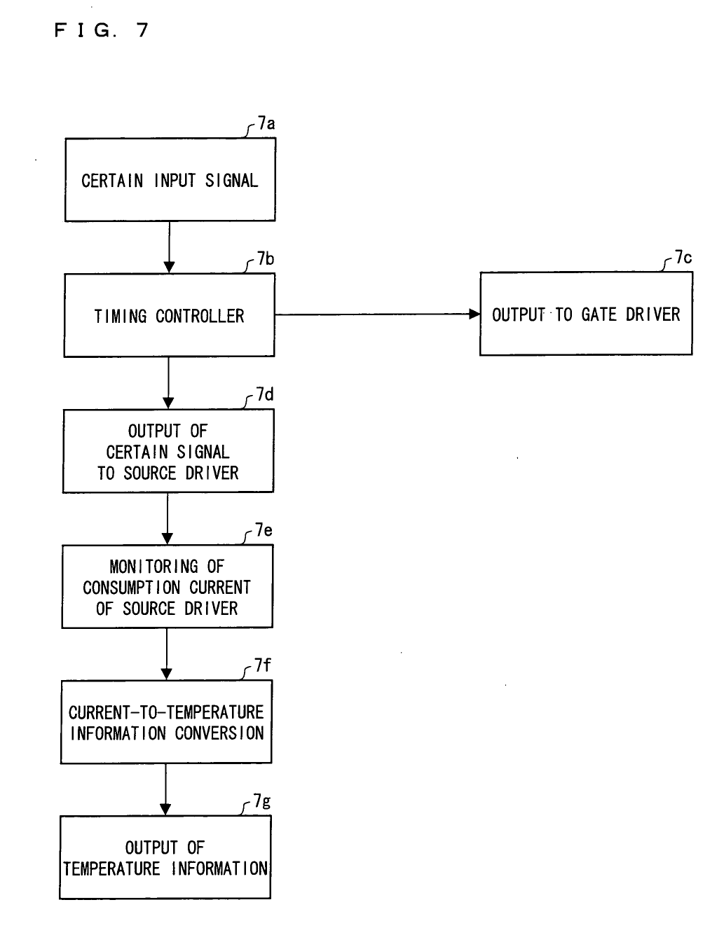

Next, with reference to FIG. 7, the following will explain another example of an operation flow of a liquid crystal temperature sensor of the present embodiment. FIG. 7 is a flow chart illustrating how the liquid crystal temperature sensor operates. The operation flow chart shown in FIG. 7 illustrates a case where a liquid crystal panel included in the liquid crystal temperature sensor is used only as a temperature sensor. That is, the present liquid crystal temperature sensor is not necessarily limited to be used for display.

Unlike the liquid crystal temperature sensor described with reference to FIG. 6, the liquid crystal temperature sensor of FIG. 7 is not used as a device for display. Therefore, the liquid crystal panel of FIG. 7 is not divided into a display region and a non-display region, and accordingly gate bus lines thereof are not divided into gate bus lines 32a for display and dummy gate bus lines 32b, either.

Therefore, the operation flow chart shown in FIG. 7 does not include the “gate driver's selection 6d”, which is illustrated in the flow chart shown in FIG. 6. This is a feature of the operation flow chart shown in FIG. 7. The operation flow is described below.

In the example shown in FIG. 7, the liquid crystal panel in the liquid crystal temperature sensor is not used as a device for display, as described above. Therefore, a timing controller 7b is supplied with a certain input signal 7a.

Then, the timing controller 7b outputs a signal to a gate driver (output to gate driver 7c), and also outputs a signal to a source driver. In this operation, the certain input signal is outputted to the source driver regardless of the gate bus line selected by the gate driver (output of certain signal to source driver 7d), since the liquid crystal temperature sensor is not used as a device for display.

Similarly to the flow described with reference to FIG. 6, after the output of the certain signal to the source driver (7d), a consumption current of the source driver is monitored (monitoring of consumption current of source driver 7e).

Then, the value of the consumption current (the amount of current) thus monitored is converted into temperature information by the current-to-temperature information converting section (current-to-temperature information conversion 7f).

Thereafter, the temperature information thus obtained is outputted (output of temperature information 7g).

### Embodiment 2

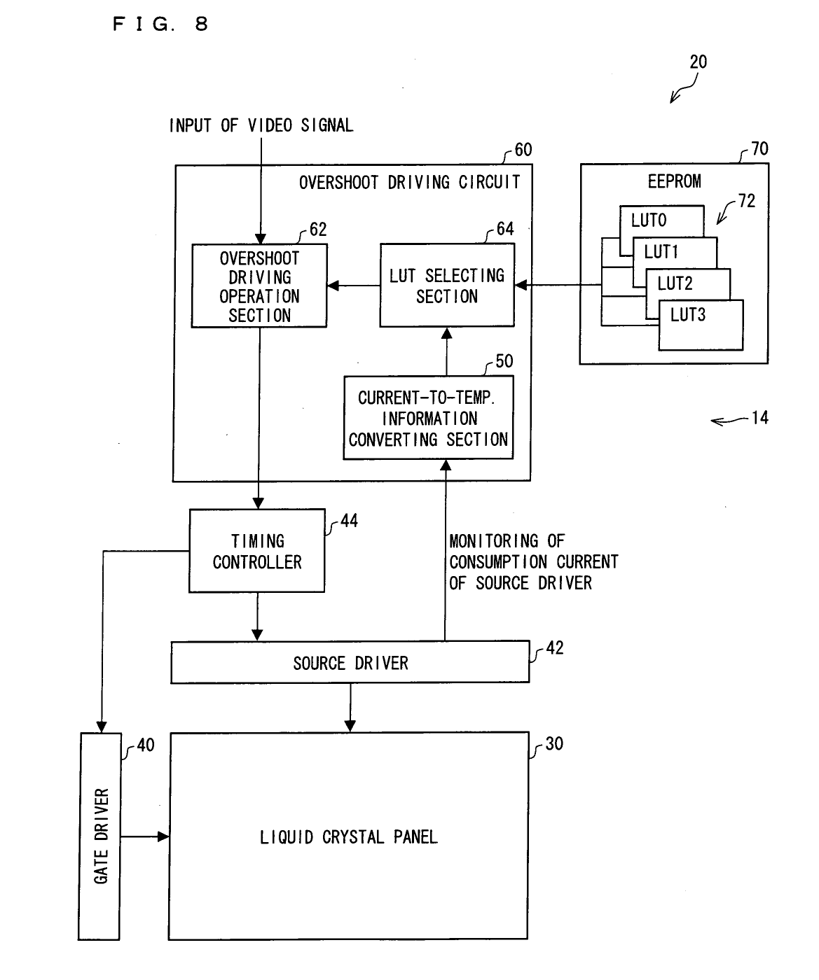

The following will explain another embodiment of the present invention with reference to FIGS. 8 through 10. Note that the configuration of Embodiment 2 is the same as that of Embodiment 1 except for the features explained for Embodiment 2. For convenience of explanation, members having the same functions as those shown in the figures for Embodiment 1 are given the same signs, and are not explained here.

A liquid crystal device 20 of the present embodiment includes, in addition to the configuration of the liquid crystal temperature sensor 10 of Embodiment 1, an overshoot driving circuit 60, which is provided in a control section 14. Thus, the liquid crystal device 20 is configured so that a liquid crystal panel 30 can be driven by overshoot driving. This is a feature of the liquid crystal device 20. The liquid crystal device 20 is described below.

FIG. 8 is a block diagram schematically illustrating a configuration of the liquid crystal device of the present embodiment.

As shown in FIG. 8, the liquid crystal device 20 of the present embodiment is configured to have the overshoot driving circuit 60 and EEPROM (Electrically Erasable/Programmable Read Only Memory) 70, in addition to a liquid crystal temperature sensor which is almost the same as the liquid crystal temperature sensor 10 described with reference to FIG. 1.

That is, in the liquid crystal device 20 of the present embodiment, a video signal serving as input tone data is not directly supplied to a timing controller 44, but is supplied to the timing controller 44 via the overshoot driving circuit 60.

Specifically, the overshoot driving circuit 60 includes an overshoot driving operation section 62 (tone converting section), a LUT (Look Up Table) selecting section 64 (selecting section), and a current-to-temperature information converting section 50.

The video signal is first supplied to the overshoot driving operation section 62, and then is supplied to the timing controller 44 as an output from the overshoot driving operation section 62.

In the liquid crystal device 20 of the present embodiment, a consumption current of a source driver 42 is monitored; based on the result of the monitoring, the current-to-temperature information converting section 50 obtains temperature information. In terms of this, the liquid crystal device 20 of the present embodiment is the same as the previously-described liquid crystal temperature sensor 10. However, in the liquid crystal device 20 of the present embodiment, the temperature information outputted from the current-to-temperature information converting section 50 is supplied to the LUT selecting section 64, which is connected with the EEPROM 70 (storing section).

Note that the EEPROM 70 stores, as LUTs (tone conversion tables), overshoot parameters optimum for respective temperatures of a liquid crystal material contained in a liquid crystal layer of the liquid crystal panel 30 which is to be driven. LUT0 through LUT3 (72) shown in FIG. 8 indicate the LUTs for the respective temperatures.

Based on the temperature information supplied from the current-to-temperature information converting section 50, the LUT selecting section 64 selects, among the plurality of LUTs 72 stored in the EEPROM 70, a LUT 72 which is suitable for the temperature, in other words, a table to be referred to by the overshoot driving operation section 62.

Note that the LUT selecting section 64 is also connected with the overshoot driving operation section 62. Information of the LUT 72 which is selected by the LUT selecting section 64 is transmitted to the overshoot driving operation section 62. Then, based on the LUT 72, the overshoot driving operation section 62 outputs to the timing controller 44 a video signal that may cause optimum overshoot driving. Namely, the overshoot driving operation section 62 optimizes a degree of tone conversion by referring to the LUT 72 which is the most suitable, carries out tone conversion on the input tone data, and outputs the resulting data.

(Operation Flow Chart)

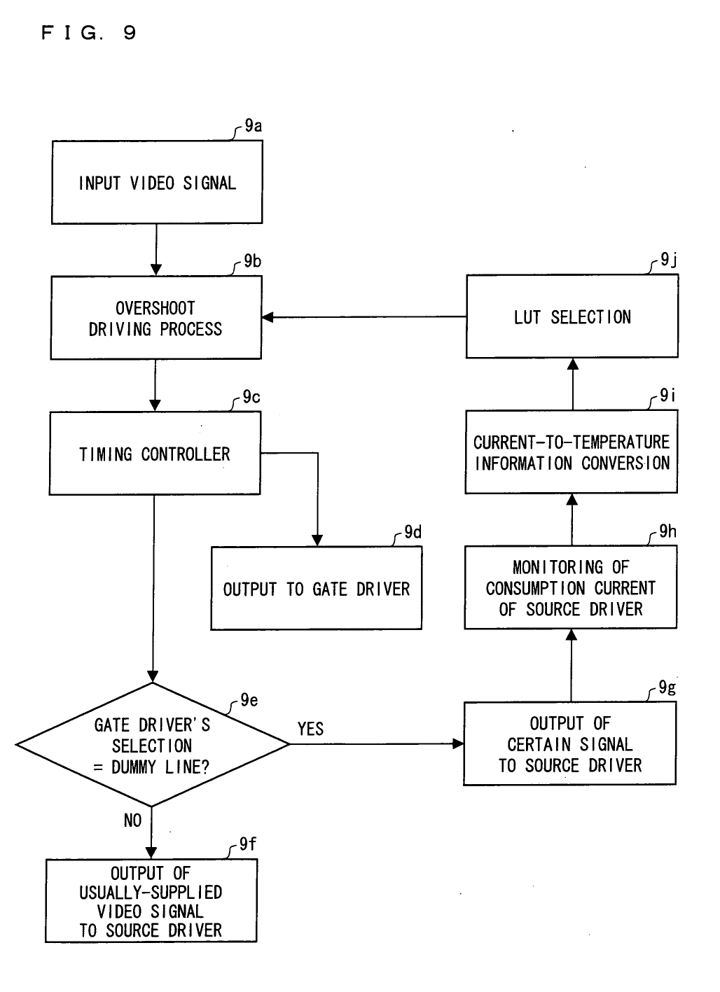

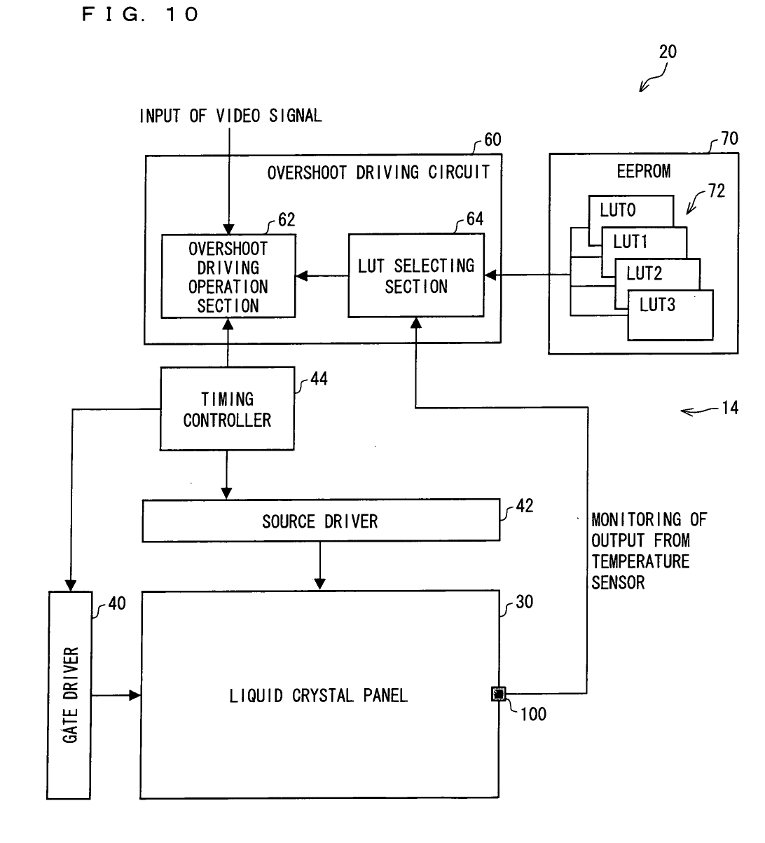

Next, with reference to FIG. 9, the following will explain in greater detail an example of an operation flow of the liquid crystal device of the present embodiment. FIG. 9 is a flow chart illustrating how the liquid crystal device operates, and shows a circuit operation of the liquid crystal device which is driven by overshoot driving according to the temperature.

In the example shown in FIG. 9, the liquid crystal panel of the liquid crystal device is used as a device for display, as described above. Therefore, a timing controller 9c is supplied with a video signal (input video signal 9a).

Since the liquid crystal device of the present embodiment is driven by overshoot driving, the input video signal is not directly supplied to the timing controller 9c, but is supplied to the timing controller 9c after being subjected to an overshoot driving process 9b by the overshoot driving circuit 60.

Specifically, the overshoot driving for the liquid crystal device of the present embodiment is carried out according to the temperature of the liquid crystal panel or the liquid crystal material. Therefore, as described later, the overshoot driving process 9b is carried out according to the temperature information.

After being subjected to the overshoot driving process 9b, the input video signal is supplied to the timing controller 9c.

Then, the timing controller 9c outputs a signal to a gate driver (output to gate driver 9d), and also outputs a signal to a source driver. In this operation, the signal to be outputted to the source driver varies depending on the gate bus line selected by the gate driver, since the liquid crystal device is used also as a device for display.

Specifically, it is determined whether a gate bus line for display is selected or a dummy gate bus line is selected (gate driver's selection 9e). If the dummy gate bus line is determined to be selected, a certain signal is outputted to the source driver (output of certain signal to source driver 9g).

Then, after the output of the certain signal to the source driver, a consumption current of the source driver is monitored (monitoring of consumption current of source driver 9h).

Subsequently, the value of the consumption current (the amount of current) thus monitored is converted into temperature information by the current-to-temperature information converting section (current-to-temperature information conversion 9i).

Thereafter, the current-to-temperature information converting section outputs to the LUT selecting section the temperature information thus obtained. Upon receipt of the temperature information, the LUT selecting section selects, among the LUTs prepared in advance for respective temperatures, a LUT which is the most suitable for a temperature represented by the temperature information received, and then feeds the LUT back to the overshoot driving process 9b.

As described previously, in the present embodiment, the overshoot driving according to the temperature is carried out. Specifically, according to the LUT thus fed back, the overshoot driving process 9b is carried out on the input video signal.

On the other hand, in the determining whether a gate bus line for display is selected or a dummy gate bus line is selected (gate driver's selection 9e), if the gate bus line for display is determined to be selected, a usually-supplied video signal is outputted to the source driver (output of certain signal to source driver 9f).

(Conventional Liquid Crystal Device)

Meanwhile, as shown in FIG. 10, a conventional liquid crystal device 20 which can be driven by overshoot driving includes a liquid crystal panel 30 to which a temperature sensor 100 is attached. FIG. 10 shows conventional art, and is a block diagram schematically illustrating a configuration of the liquid crystal device.

Specifically, as shown in FIG. 10, the conventional liquid crystal device 20 driven by overshoot driving according to the temperature includes the liquid crystal panel 30 to which the temperature sensor 100 is additionally attached, as an extra component, in addition to the liquid crystal panel 30, etc., the temperature sensor 100 detecting a temperature of the liquid crystal panel 30. Further, in the conventional liquid crystal device 20, after the temperature sensor 100 detects temperature information, the temperature sensor 100 outputs the temperature information so that the temperature information is supplied to a LUT selecting section 64.

Since the conventional liquid crystal device 20 does not obtain the temperature information based on a current consumed by the liquid crystal panel 30, the conventional liquid crystal device 20 does not include a current-to-temperature information converting section 50. Thus, an overshoot driving circuit 60 of the conventional liquid crystal device 20 includes an overshoot driving operation section 62 and the LUT selecting section 64 only.

Upon receipt of the temperature information, the LUT selecting section 64 selects, from EEPROM 70 connected with the LUT selecting section 64, a LUT 72 having been optimized for the temperature.

As described previously, the EEPROM 70 stores, as LUTs, overshoot parameters optimum for respective temperatures of a liquid crystal material which is to be driven.

The LUT selecting section 64 is also connected with the overshoot driving operation section 62, and information of the LUT 72 selected by the LUT selecting section 64 is transmitted to the overshoot driving operation section 62. Then, based on the LUT 72, the overshoot driving operation section 62 outputs to a timing controller 44 a video signal that may cause optimum overshoot driving.

(Effects)

In the conventional configuration shown in FIG. 10, the temperature sensor 100 is manufactured and provided to the liquid crystal panel 30, additionally as an extra component. Therefore, as described previously, such the conventional configuration involves problems of, e.g., (i) increasing the manufacturing cost and (ii) being incapable of accurately detecting a temperature of the liquid crystal material.

On the other hand, the liquid crystal device of the present invention obtains temperature information with use of bus lines, drivers, etc., each of which is incorporated in advance into the liquid crystal panel. Accordingly, an increase in the number of manufacturing steps and the manufacturing cost can be easily prevented.

Further, as described previously, since the liquid crystal device of the present invention obtains temperature information from part of the liquid crystal panel in which part the liquid crystal panel and the liquid crystal material are in contact with each other. This makes it easier to detect the temperature accurately.

(Position for Monitoring)

The foregoing explanation has dealt with the arrangement for monitoring an amount of current flowing into the picture elements connected with the respective dummy gate bus lines, which are provided in both of upper and lower non-display regions in the liquid crystal panel.

Here, how the amount of current thus monitored is dealt with is explained specifically. For example, an average value of (i) an amount of current (current on the upper side) flowing into a picture element connected with a dummy gate bus line provided in a non-display region which is close to an upper side (when viewed in the Y direction) of the liquid crystal panel and (ii) an amount of current (current on the lower side) flowing into a picture element connected with a dummy gate bus line provided in a non-display region which is close to a lower side (when viewed in the Y direction) of the liquid crystal panel can be converted into temperature information.

As an alternative method, for example, the following methods are considered. (i) A method for converting, into temperature information, only either one of (a) the amount of the current on the upper side and (b) the amount of the current on the lower side. (ii) A method for (a) calculating a weighted average amount of current while giving different weightings to the current on the upper side and the current on the lower side and (b) converting the value of the weighted average amount of current into temperature information.

Thus, it is possible to obtain, in different ways, the amount of current which is to be converted into the temperature information. Consequently, it is possible to detect the temperature and to carry out the overshoot driving appropriately according to the temperature distribution in the liquid crystal panel surface.

(Signal to be Applied)

In the case where the liquid crystal panel is not used as a device for display, the picture element for which the amount of current is to be monitored is not limited to the picture element connected with the dummy gate bus line, and may be any picture element in the liquid crystal panel, as described previously. The reason for this is as follows: In such the liquid crystal panel, it is not necessary to supply a video signal to the picture elements, and therefore it is possible to supply any signal (e.g., the previously-described certain input signal) to the picture elements.

On the other hand, in the case where the liquid crystal panel is used as a device for display, an amount of current flowing into the picture elements in the non-display region is monitored. This makes it possible to apply to the picture elements any signal (e.g., the previously-described certain input signal) suitable for the monitoring of the amount of current, as described previously.

Note that the signal to be supplied for the monitoring of the amount of current is not limited to the previously-described certain input signal, and may be any signal. However, it is preferable to apply a signal having a constant electric potential, since this makes it easier to monitor a change in the amount of current.

(Driving Method)

The foregoing has exemplified the configuration including, as the switching element, the transistor element (TFT element), which is a three-terminal element. However, the present invention is not limited to this configuration, as long as it allows active driving. Alternatively, for example, a two-terminal element such as MIM (Metal Insulator Metal) may be used as the switching element.

(Others)

Further, the foregoing has explained the configuration for monitoring, via the source driver, the amount of current which has been flown into the picture elements. However, the present invention is not limited to this configuration. Alternatively, for example, the amount of current can be monitored by other methods.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

According to the present invention, it is possible to detect a temperature of a liquid crystal material economically and accurately. Therefore, the present invention is applicable to liquid crystal panels which require accurate temperature information, for example, liquid crystal devices which is driven by overshoot driving.

### REFERENCE SIGNS LIST

10 Liquid crystal temperature sensor
14 Control section
20 Liquid crystal device
26 First substrate
28 Second substrate
30 Liquid crystal panel
32 Gate bus line (signal line)
32b Dummy gate bus line
34 Source bus line (signal line)
36 Switching element
38 Picture element
38b Dummy picture element (picture element belonging to non-display region)
40 Gate driver
42 Source driver
46 Liquid crystal layer
50 Current-to-temperature information converting section
60 Overshoot driving circuit
62 Overshoot driving operation section (tone converting section)
64 LUT selecting section (selecting section)
70 EEPROM (storing section)
72 LUT (tone conversion table)
R10 Display region
R20 Non-display region

1. A liquid crystal temperature sensor comprising:
a liquid crystal panel including a first substrate, a second substrate, and a liquid crystal layer sandwiched between the first substrate and the second substrate; and
a control section for controlling driving of the liquid crystal panel,
the liquid crystal panel including a plurality of picture elements arranged in a matrix,
the control section including a current-to-temperature information converting section for (i) detecting an amount of current flowing into at least one of the picture elements and (ii) converting the amount of current detected, into temperature information of part of the liquid crystal layer which part corresponds to said at least one of the picture elements.

2. The liquid crystal temperature sensor as set forth in claim 1, wherein:
the current-to-temperature information converting section stores information regarding a correlation between the amount of current and the temperature information; and
based on the information regarding the correlation, the current-to-temperature information converting section converts the amount of current detected, into the temperature information.

3. The liquid crystal temperature sensor as set forth in claim 1, wherein:
the first substrate includes (i) a plurality of signal lines intersecting with each other and (ii) switching elements correspondingly provided to intersections of the plurality of signal lines;
the plurality of signal lines include source bus lines and gate bus lines wherein the source bus lines and the gate bus lines intersect with each other at the intersections so as to be connected with the respective switching elements correspondingly;
the switching elements are transistor elements;
the control section includes (i) a source driver for controlling the source bus lines and (ii) a gate driver for controlling the gate bus lines; and
the current-to-temperature information converting section detects a consumption current of the source driver so as to detect the amount of current flowing into said at least one of the picture elements.

4. The liquid crystal temperature sensor as set forth in claim 1, wherein:
the liquid crystal panel includes (i) a display region, which displays an image, and (ii) a non-display region, which does not display the image, the non-display region being provided along an outer edge of the display region; and
each of said at least one of the picture elements for which the amount of current is detected is a picture element belonging to the non-display region.

5. The liquid crystal temperature sensor as set forth in claim 3, wherein:
the liquid crystal panel includes (i) a display region, which displays an image, and (ii) a non-display region, which does not display the image, the non-display region being provided along an outer edge of the display region; and
among the picture elements, a picture element belonging to the non-display region includes, among the switching elements, a switching element connected with a corresponding dummy gate bus line, which is, among the gate bus lines, a gate bus line provided for inspection of the liquid crystal panel.

6. The liquid crystal temperature sensor as set forth in claim 4, wherein:
the second substrate includes a black matrix; and
the non-display region is covered with the black matrix when seen in a plane view.

7. The liquid crystal temperature sensor as set forth in claim 1, wherein:
the first substrate includes the plurality of signal lines intersecting with each other; and
each of the picture elements is demarcated by corresponding ones of the plurality of signal lines intersecting with each other.

8. A liquid crystal device comprising:
a liquid crystal temperature sensor as set forth in claim 1, the liquid crystal temperature sensor including the liquid crystal panel which is driven by overshoot driving according to input tone data having been subjected to tone conversion with reference to a tone conversion table,
the control section including:
a storing section for storing a plurality of tone conversion tables in which respective different degrees of tone change are set for tone conversion;
a selecting section for selecting, among the plurality of tone conversion tables, a tone conversion table to be referred to; and
a tone converting section for carrying out tone conversion on the input tone data by referring to the tone conversion table selected,
the selecting section selecting, among the plurality of tone conversion tables stored in the storing section, the tone conversion table which is suitable for a temperature of the liquid crystal layer, based on the temperature information supplied by the current-to-temperature information converting section.

9. A method for detecting a temperature of a liquid crystal layer in a liquid crystal temperature sensor, wherein the liquid crystal temperature sensor includes:
a liquid crystal panel including a first substrate, a second substrate, and the liquid crystal layer sandwiched between the first substrate and the second substrate; and
a control section for controlling driving of the liquid crystal panel,
the liquid crystal panel including a plurality of picture elements arranged in a matrix,
said method comprising the steps of:
detecting an amount of current flowing into at least one of the picture elements; and
converting the amount of current detected, into temperature information.

10. The method as set forth in claim 9, wherein:
the first substrate includes (i) a plurality of signal lines intersecting with each other and (ii) switching elements correspondingly provided to intersections of the plurality of signal lines;
each of the picture elements is demarcated by corresponding ones of the plurality of signal lines intersecting with each other.

11. A method for driving a liquid crystal device, wherein the liquid crystal device includes:
a liquid crystal panel including a first substrate, a second substrate, and a liquid crystal layer sandwiched between the first substrate and the second substrate; and
a control section for controlling driving of the liquid crystal panel,
the liquid crystal panel including a plurality of picture elements arranged in a matrix,
the control section includes:
a current-to-temperature information converting section for (i) detecting an amount of current flowing into at least one of the picture elements and (ii) converting the amount of current detected, into temperature information of part of the liquid crystal layer which part corresponds to said at least one of the picture elements;
a storing section for storing a plurality of tone conversion tables in which respective different degrees of tone change are set for tone conversion;
a selecting section for selecting, among the plurality of tone conversion tables, a tone conversion table to be referred to; and
a tone converting section for carrying out tone conversion on input tone data by referring to the tone conversion table selected,
said method comprising the steps of:
the current-to-temperature information converting section detecting an amount of current flowing into said at least one of the picture elements;
the current-to-temperature information converting section converting the amount of current detected, into temperature information;
based on the temperature information, the selecting section selecting, among the plurality of tone conversion tables stored in the storing section, a tone conversion table which is suitable for a temperature of the liquid crystal layer;
the converting section carrying out tone conversion on input tone data by referring to the tone conversion table selected; and
based on the input tone data on which the tone conversion has been carried out, driving the liquid crystal panel by overshoot driving.

12. The method as set forth in claim 11, wherein:
the first substrate includes (i) a plurality of signal lines intersecting with each other and (ii) switching elements correspondingly provided to intersections of the plurality of signal lines;
each of the picture elements is demarcated by corresponding ones of the plurality of signal lines intersecting with each other.
